(19) United States
(12) Patent Application Publication
(10) Pub. No.: US 2011/0231864 A1
(43) Pub. Date: Sep. 22, 2011

(54) Systems and Methods for Dynamic Configuration and Control of Multi Function Peripherals

(75) Inventors: Ranga Raj B.K, Bangalore (IN); Sanjiv Shet, Bangalore (IN); Robert Shibata, Torrance, CA (US); Shunmuga Kumaraswamy, Bangalore (IN)

(73) Assignee: THINXTREAM TECHNOLOGIES PTE. LTD., SINGAPORE (SN)

(21) Appl. No.: 12/728,163

(22) Filed: Mar. 19, 2010

(51) Int. Cl. G06F 9/46; G06F 9/44; H04L 9/32

(52) U.S. Cl. 719/321; 719/328; 726/2

(57) ABSTRACT

Computer-implemented methods and systems for dynamic configuration and control of multi-function peripherals. A method comprises exposing a unified application programming interface (API) for operating a plurality of MFPs, receiving a first set of instructions from an application according to the API, the instructions directed to a first MFP; receiving a second set of instructions from the application according to the API, the instructions directed to a second MFP; translating the first set of instructions according to the native set of instruction of the first MFP, and sending the translated instructions to the first MFP; translating the second set of instructions according to the native set of instructions of the second MFP, and sending the translated instruction to the second MFP; thereby allowing the application to communicate with the first and second MFPs according to a unified API. The embodiments also allow for dynamic device discovery, and for matching advertised device capabilities to requests, among other things.

### BACKGROUND

1. Field

The present embodiments pertain to configuration and control of multi-function peripherals, and in particular to computer-implemented methods and systems disclosed for the dynamic configuration and control of multi-function peripherals.

2. Related Art

Today, when multi-function peripherals (MFPs) are shipped by their manufacturers, no methodology is provided for changing the MFPs' capabilities, functions, and features in the field. This is in contrast to general purpose desktop, laptop, or mobile devices that can be extended with downloadable software. Printers, for example, comprise the same set of functionalities from shipment to the time they are retired and recycled. Similarly, MFPs in general do not extend their capabilities in the field according to the needs of the organization and the users.

At the same time, different business verticals have different use cases for the same set of MFPs, drawing on different application level and device level capabilities of the MFPs. Such variety of use cases ultimately originate in a specific vertical's business needs, security requirements, required authorizations, etc. In the past, this has prompted third parties to take a generic MFP provider's platform, customize it, and sell it as a shrink-wrapped product. While this approach has its benefits, it is contemplated that dynamically configurable MFPs would be a more cost-effective and dynamic solution.

Therefore, it would be desirable to have MFPs that can dynamically configure and tune their capabilities in the field post-shipment, based on instructions received over a network and via functionality and management interfaces exposed by the MFPs. In particular, it would be desirable to allow MFPs to add user profiles, privileges, roles, or accesses, and thereby allow MFPs to effectively morph themselves into providing a variety of functionalities based on credentials. It would also be desirable to have MFPs that allow payments for usage, among other things. The present invention addresses these and other needs, and disclosed herein.

### SUMMARY

Computer-implemented methods and systems are disclosed for dynamic configuration and control of multi-function peripherals. In one embodiment, the method comprises exposing a unified application programming interface (API) for operating a plurality of MFPs; receiving a first set of instructions from an application according to the API, the instructions directed to a first MFP; receiving a second set of instructions from the application according to the API, the instructions directed to a second MFP; translating the first set of instructions according to the native set of instructions of the first MFP, and sending the translated instructions to the first MFP; translating the second set of instructions according to the native set of instructions of the second MFP, and sending the translated instruction to the second MFP; thereby allowing the application to communicate with the first and second MFPs according to a unified API.

In one aspect, the first set of instructions pertains to a functionality of the first MFP. In one aspect, the functionality is a printing functionality, a scanning functionality, or a faxing functionality.

In one aspect, the first set of instructions pertains to a management function of the first MFP. In one aspect, the management function is a configuration function, a diagnostic function, or a software upgrade function. In another aspect, the management function is a usage audit function, a usage management function, or a monitoring function.

In one aspect, the method further comprises authenticating the application prior to the translating and sending steps. In one aspect, the authenticating comprises communicating with an external authentication system.

In one aspect, the exposing and receiving steps are according to a Service Oriented Architecture (SOA) based framework. In one aspect, the translating steps are performed by an SOA broker or a web service translator.

Further systems and methods are disclosed, as set forth in the detailed description.

### BRIEF DESCRIPTION OF DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1 is a block diagram illustrating a system for dynamic configuration and control of multi-function peripherals, in accordance with an embodiment of the present invention.

FIG. 2 is a block diagram illustrating in more details a system for dynamic configuration and control of multi-function peripherals, in accordance with an embodiment of the present invention.

FIG. 3 is a flow diagram illustrating a method for dynamic configuration and control of multi-function peripherals, in accordance with an embodiment of the present invention.

FIG. 4 is a flow diagram illustration a method for dynamic control and configuration of multi-function peripherals, in accordance with an embodiment of the present invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present embodiments provide methods and systems for dynamically accessing, configuring, and controlling multi-function peripherals (hereinafter also referred to as MFPs, or devices) according to users and/or applications which use such MFPs. Dynamically reconfigurable MFPs are disclosed which allow for extension and configuration of their capabilities and functionalities post-shipment. A middleware software is disclosed which is configured to expose one or more application programming interfaces (hereinafter also referred to as APIs) for operating a plurality of MFPs from a variety of vendors. It is further contemplated that MFPs, as described herein, may advertise (or otherwise make known) one or more of their capabilities to the middleware software, and the middleware software may in turn match such available capabilities to requests for such capabilities received from users or programs.

The middleware software, upon receiving instructions via such APIs, translates the received instructions from the language or format of the API to one or more specific MFP manufacturers' languages or formats, preferably in real-time, and passes the translated instructions to one or more such MFPs. As a result, software developers may write and maintain one set of instructions according to MFP independent exposed APIs, and leave the translation of such instructions, as well as transmission to one or more discovered MFPs, to the middleware software. As should be obvious to those of ordinary skill in the art, in the case of MFPs that are pre-configured to operate in accordance with such APIs, the middleware software may pass the instructions without translation.

In practice, the middleware software may reside on a web server, or on a similarly suitable system accessible to users and/or applications that use such APIs to interface with MFPs. Advantageously, in such an embodiment implemented via web services, the web service providers would not need to discover or send metadata directly to the MFPs, but would instead send such information to the middleware software, via the exposed APIs. The middleware software would discover the MFPs on the network and transmit their specific open architecture requirements over the network. Advantageously, there would not be any need for modifications or changes to the MFP manufacturer's requirements.

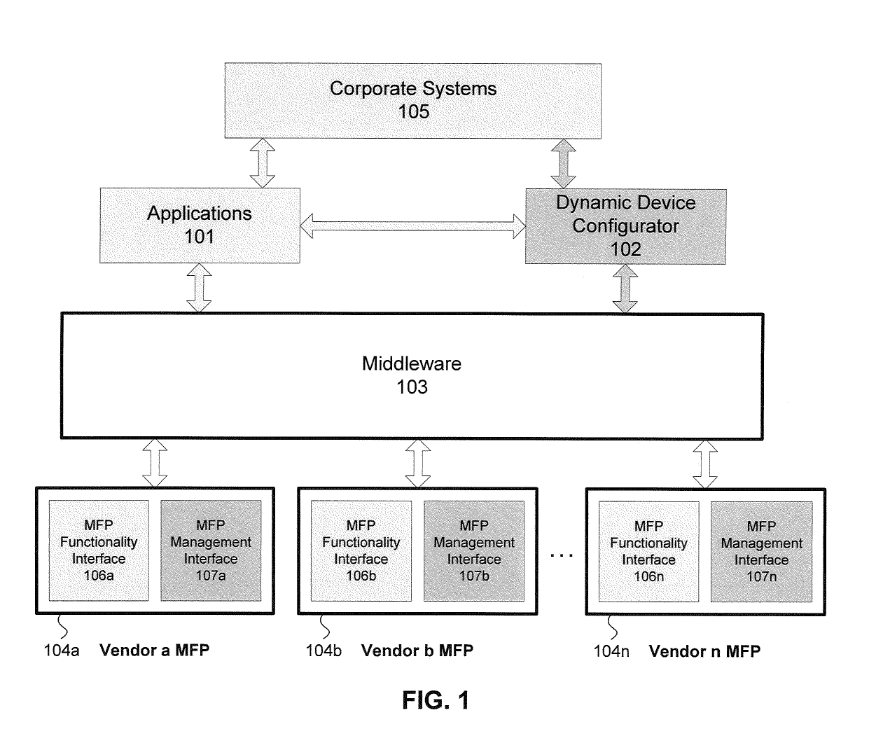

FIG. 1 is a block diagram illustrating a system for dynamic configuration and control of multi-function peripherals, in accordance with an embodiment of the present invention. One or more applications 101 and/or one or more dynamic device configurators 102 are configured to communicate, via a middleware software 103, with one or more multi-function peripherals 101. FIG. 1 shows MFPs 104a, 104b, . . . , 104n as exemplary MFPs manufactured by vendors a, b, . . . , n. Higher level corporate systems 105 in turn may operate MFPs 104 by indirectly going through applications 101 and dynamic device configurators 102.

MFPs 104 are dynamically reconfigurable and provide functionality and management interfaces for tuning their capabilities in the field post-shipment, based on instructions received over a network. For example, the MFPs may allow addition of user profiles, privileges, roles, or accesses, thereby effectively morphing themselves into providing a variety of functionalities based on credentials. As another example, the MFPs may allow charges or payments for usage. As another example, the MFPs may allow addition or deletion of applications that run on the MFPs, and allow enabling or disabling aspects of their functionalities in the field (rather than simply at time of shipment). Such dynamic configuration in the field accommodates vertical business needs, security capabilities, authorizations, etc.

Typically, applications 101 are configured to use functionalities of the MFPs 104, such as printing, scanning, faxing, etc., while dynamic device configurators 102 use management capabilities of the MFPs 104, such as configuring an MFP, performing diagnostics, performing software upgrades or patch management, reconfiguring authentication protocols, usage management, usage audits, asset utilization, asset optimization, device monitoring, etc. For this purpose, MFPs expose interfaces for their functionalities as well as interfaces for their management functions. Such interfaces are shown in FIG. 1 as MFP functionality interfaces 106a, 106b, . . . , 106n, and MFP management interfaces 107a, 107b, . . . , 107n.

It is noted that while MFPs 104 expose interfaces for their functionalities as well as their management capabilities, these need not be exposed through the same interface. For example, the management interface may use traditional communication interfaces such as Simple Network Management Protocol (SNMP) ports or public ports, while the functionality interface may be exposed using a proprietary interface, or through web services, Java, etc.

Middleware software 103 effectively acts as an intermediary and translator between applications 101 and dynamic device configurators 102, on one side, and a variety of MFPs 101 manufactured by a variety of vendors exposing a variety of MFP-specific functionality and management interfaces, on the other side. The middleware software 103 is configured to translate communications between the two sides in a manner that is transparent to the communicating parties, as will now be described in more detail. As should be known to those of ordinary skill in the art, middleware software 103 may be implemented using any suitable computing device, such as a computing device comprising a controller (e.g., a processor or CPU) and a memory configured to store executable instructions for carrying out the operations of the middleware software 103 as described herein.

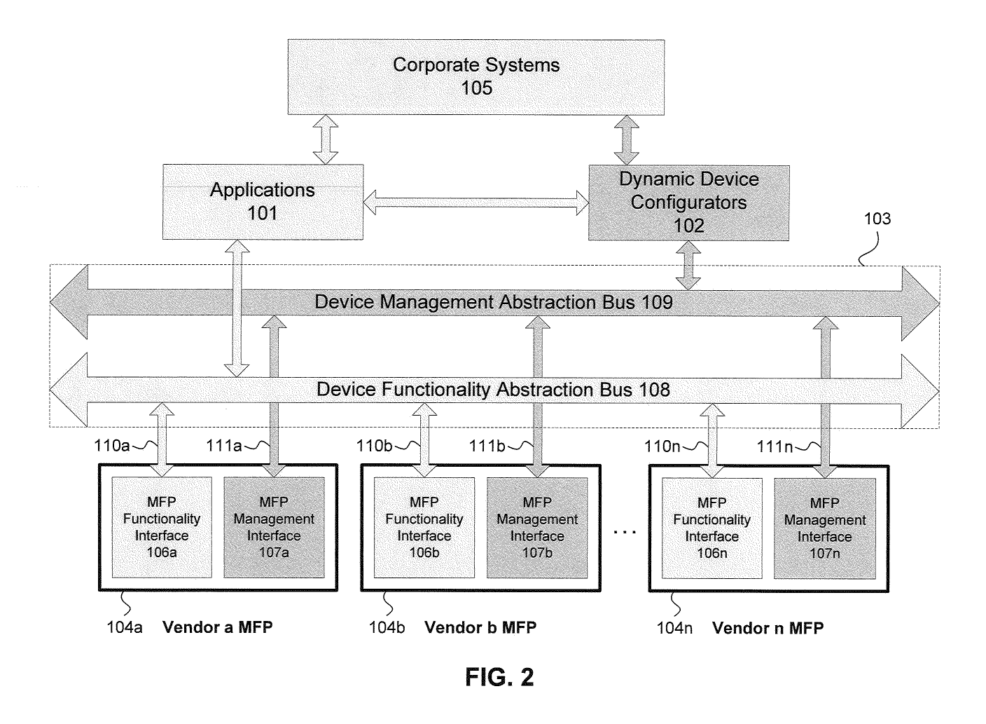

FIG. 2 is a block diagram illustrating in more details a system for dynamic configuration and control of multi-function peripherals, in accordance with an embodiment of the present invention. Corresponding to the MFP functionality and management interfaces 106 and 107, middleware software 103 comprises two translation elements, shown for illustration purposes as “buses” in FIG. 2: the first is the device functionality abstraction bus 108, and the second is the device management abstraction bus 109.

The functionality abstraction bus 108 of middleware 103 is configured to expose a functionality interface according to a generalized API, which developers of applications 101 can use to communicate with any one of the MFPs 104a, 104b, . . . , 104n, without resorting to low-level programming based on MFP specific parameters. In practice, functionality abstraction bus 108 may be configured according to one or more particular standards.

In one particular implementation, functionality abstraction bus 108 may be configured according to a Service Oriented Architecture (SOA) based framework, comprising one or more translators (e.g., brokers, connectors, or web service translators) which translate vendor specific APIs (in terms of MFP functionality) into a standards based framework, such as an eXtensible Markup Language (XML) framework. Additionally, and in order to provide a functionality interface which can be used for developing software programs that interface with a variety of MFPs without having to hardcode vendor specific parameters, this standards based framework itself may be translated into a generic MFP functionality API Software Development Kit (SDK). The MFP specific functionality translations provided by the various SOA brokers or connectors are denoted by the arrows labeled 110a, 110b, . . . , 110n.

Similarly, the management abstraction bus 109 of middleware 103 is configured to expose a management interface according to a generalized API, which dynamic device configurators 102 can use to communicate with and control any one of the MFPs 104a, 104b, . . . , 104n, without resorting to low-level programming based on MFP specific parameters. In practice, similar to the functionality abstraction bus 108, the management abstraction bus 109 may be configured according to one or more particular standards. In particular, management abstraction bus 109 may be exposed to developers or applications of management services platforms. The MFP specific management translations provided by the various translators (e.g., brokers, connectors, or web service translators) are denoted by the arrows labeled 111a, 111b, . . . , 111n.

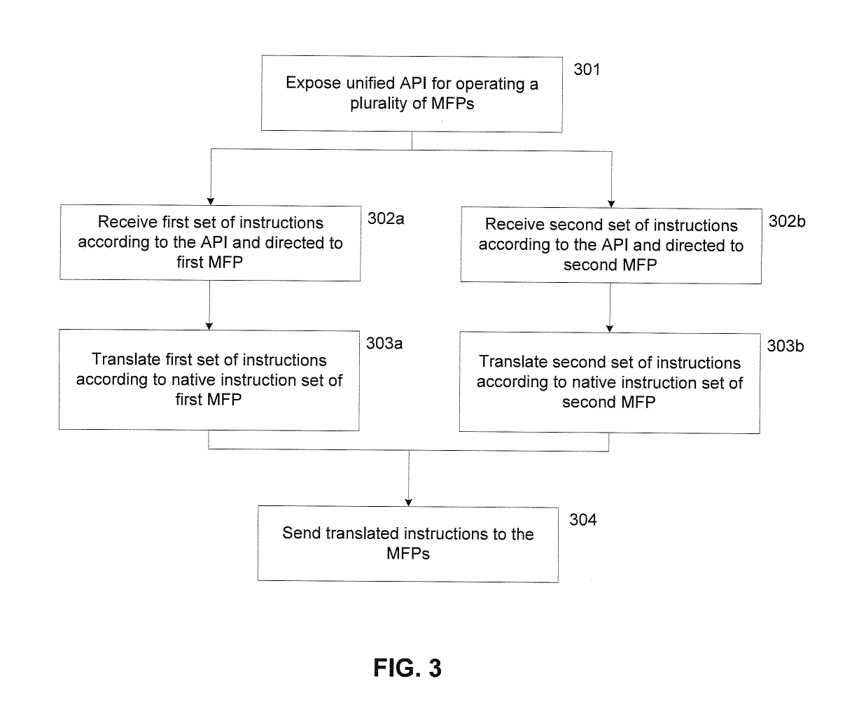

We now turn to describing the exposure of unified API and the translation of received instructions directed to specific MFPs in more detail. FIG. 3 is a flow diagram illustrating a method for dynamic configuration and control of multi-function peripherals, in accordance with an embodiment of the present invention. At step 301, a unified API is exposed for operating a plurality of MFPs. For example, the unified API may be exposed by the middleware software 103 and implemented via the functionality and management buses 108 and 109, as described above.

At steps 302a and 302b, a first and second set of instructions directed to a first and second MFP are received (respectively), wherein the instructions are according to the exposed unified API. While these instructions are directed to different MFPs with potentially different vendor specific instruction sets, there are advantageously formulated in a unified MFP independent API.

At steps 303a and 303b, the first and second sets of instructions are translated from the unified API to the native instruction sets of the first and second MFPs, respectively. This step translates the unified API instructions to native instructions suitable for consumption by the MFPs. At step 304, the translated first and second sets of instructions are sent to the first and second MFPs, respectively.

As a specific example of using the above described systems for dynamic control and configuration or multi-function peripherals, we consider an example corporate system 105 which operates its MFPs according to a collection of business rules, roles and access restrictions, specific workflows, identity management schemes, payment gateways, etc. Users may access MFPs in a variety of ways, such as by using an MFP's front panel, or by using a software application that interfaces with an MFP. In one embodiment, the rules may be configured such that different users would be granted different rights and/or privileges as regarding to MFP functionality. Optionally and additionally, different users may be granted different access privileges to specific applications within the MFPs, hence the need for a management abstraction functionality that allows for dynamically configuring and controlling an MFP. Note that the users may include users local to the location of the MFP, as well as remote users, traveling salespersons, traveling audit persons, etc.

Once a user is identified, for example by logging in through an application, using a biometric scan on the MFP front panel, using an identification card, or any other suitable mechanism, the user is authenticated based on the access privileges that they have been granted. Optionally and additionally, the system also detects one or more of: the users' roles, their departments, the associated cost centers, or other relevant information about the users. Note that this may optionally proceed independently of any local authentication that the users may have to go through to gain access to the MFP interface.

Thereafter, based on the business rules in operation (e.g., based on authorizations, access to a profile of applications, device capabilities, limits on usage, workflow, etc.), the functionality abstraction bus 108 (in cooperation with the particular translator 106 for the particular MFP at hand) may allocate certain features and functionality of the MFP for the user. Note that this step may be done by interfacing with one or more other corporate systems. Optionally, if there are any cross-charges, payments, or other similar processing to be done on a pay-per-use basis, they can also be processed at that time. The system is now ready for the application and/or the user, and is customized for the needs or roles of the user. Advantageously, note that this scenario does not require that the user be located at or near the MFP; in contrast, the user may very well be geographically remote to the MFP, for example when the user is operating an MFP remotely via a network software application. Similar to the exposed MFP functionalities, the management abstraction bus 109 may expose the management functionalities of the MFP to which the user has access privileges. Thereby, the present system provides multi-vendor, multi-geography, closed-loop, dynamically configurable MFPs to users and/or applications, such that vendor specific parameters are abstracted out. Such personalization of MFPs is similar to a remote desktop configured for a particular user, in what may be illustratively referred to as a “myMFP” for that user. Advantageously, this means that wherever the user travels in the world, the user is provided with the same or a similarly configured MFP, regardless of the location of user, the vendor of that particular MFP, etc.

In another use case, a user may log into an application and be authenticated by the application. The application may then configure the MFP on behalf of the user (using the exposed functionality and management abstraction buses 108 and 109 described above). Thereafter, the dynamically configured MFP performs as requested, and may send an acknowledgment to the application, thereby closing the control loop. In such a use case, the application may need access to internal or external systems where such information is defined, such as a Lightweight Directory Access Protocol (LDAP) system, or any other such system.

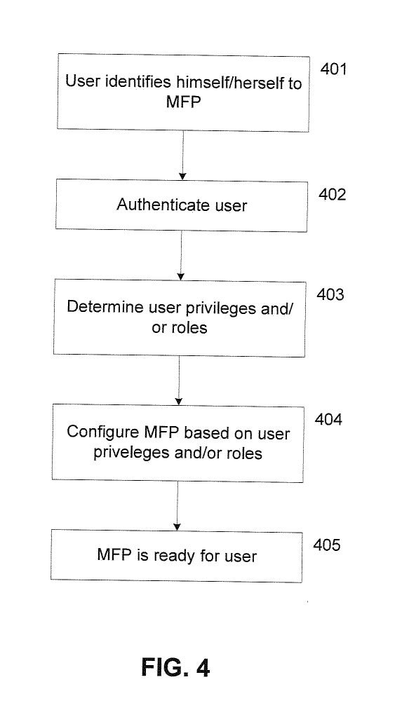

Accordingly, FIG. 4 is a flow diagram illustrating a method for dynamic control and configuration of multi-function peripherals. At step 401, a user identifies himself/herself to an MFP. Examples include using a touchscreen on the MFP to enter a user name and password, using a biometric identification system, using a smart card, authenticating remotely through a software application, etc. This steps proceeds via the abstraction busses 108 and/or 109 above, and is therefore not MFP or vendor specific.

At step 402, the user is authenticated, and at step 403 his/her role or access privileges are determined, including the types of applications granted for access. As mentioned above, this can be accomplished by interfacing with one or more appropriate corporate systems. At step 404, based on the obtained approvals, access to a profile of applications, device capabilities, limits of usage, workflow, etc., are granted and the device manager automatically configures the appropriate systems or devices based on the obtained approvals (including any cross-charges, payments, etc.). At step 405, the device is ready for the application and/or the user, and is customized for the needs and roles of the user.

It is noted that the above descriptions and accompanying diagrams represent logical, and not necessarily physical, architectures, i.e., the MFPs may be in a single location or office, or they may be spread across multiple geographies. It is also noted that the MFP interfaces may be used by other management systems over and above those used for MFP configuration; such management systems may be audit systems for tracking usage of MFPs, systems for optimizing distribution or configuration of MFPs, etc. It is further noted what while reference has been made to MFPs, the present embodiments are applicable to other devices, as should be obvious to those of ordinary skill in the art.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure or the scope of the accompanying claims.

We claim:

1. A computer-implemented method for dynamic configuration and control of multi-function peripherals (MFPs), comprising:
exposing a unified application programming interface (API) for operating a plurality of MFPs;
receiving a first set of instructions from an application according to the API, the instructions directed to a first MFP;
receiving a second set of instructions from the application according to the API, the instructions directed to a second MFP;
translating the first set of instructions according to the native set of instructions of the first MFP, and sending the translated instructions to the first MFP;
translating the second set of instructions according to the native set of instructions of the second MFP, and sending the translated instruction to the second MFP;
thereby allowing the application to communicate with the first and second MFPs according to a unified API.

2. The method of claim 1, further comprising:
discovering the first or second MFP on a communication network.

3. The method of claim 1, wherein the first set of instructions pertains to a functionality of the first MFP.

4. The method of claim 3, wherein the functionality is a printing functionality, a scanning functionality, or a faxing functionality.

5. The method of claim 1, wherein the first set of instructions pertains to a management function of the first MFP.

6. The method of claim 5, wherein the management function is a configuration function, a diagnostic function, or a software upgrade function.

7. The method of claim 6, wherein the management function is a usage audit function, a usage management function, or a monitoring function.

8. The method of claim 1, further comprising authenticating the application prior to the translating and sending steps.

9. The method of claim 7, wherein the authenticating comprises communicating with an external authentication system.

10. The method of claim 1, wherein the exposing and receiving steps are according to a Service Oriented Architecture (SOA) based framework.

11. The method of claim 10, wherein the translating steps are performed by an SOA broker or a web service translator.

12. A system for dynamic configuration and control of multi-function peripherals (MFPs), comprising:
a processor; and
a memory, the memory comprising computer-executable instructions for:
exposing a unified application programming interface (API) for operating a plurality of MFPs;
receiving a first set of instructions from an application according to the API, the instructions directed to a first MFP;
receiving a second set of instructions from the application according to the API, the instructions directed to a second MFP;
translating the first set of instructions according to the native set of instructions of the first MFP, and sending the translated instructions to the first MFP;
translating the second set of instructions according to the native set of instructions of the second MFP, and sending the translated instruction to the second MFP;
thereby allowing the application to communicate with the first and second MFPs according to a unified API.

13. The systems of claim 12, wherein the memory further comprises computer-executable instructions for:
discovering the first or second MFP on a communication network.

14. The system of claim 12, wherein the first set of instructions pertains to a functionality of the first MFP.

15. The system of claim 14, wherein the functionality is a printing functionality, a scanning functionality, or a faxing functionality.

16. The system of claim 12, wherein the first set of instructions pertains to a management function of the first MFP.

17. The system of claim 16, wherein the management function is a configuration function, a diagnostic function, or a software upgrade function.

18. The system of claim 17, wherein the management function is a usage audit function, a usage management function, or a monitoring function.

19. The system of claim 12, the memory further comprising computer-executable instructions for authenticating the application prior to the translating and sending steps.

20. The system of claim 18, wherein the authenticating comprises communicating with an external authentication system.

21. The system of claim 12, wherein the exposing and receiving steps are according to a Service Oriented Architecture (SOA) based framework.

22. The system of claim 21, wherein the translating steps are performed by an SOA broker or a web service translator.

23. A computer-implemented method for dynamically interfacing with multi-function peripherals (MFPs), comprising:
exposing a unified application programming interface (API) for operating a plurality of MFPs;
discovering an MFP on a communication network;
receiving information from the MFP indicating one or more capabilities of the MFP;
receiving a first request from an application according to the API;
matching the request to the one or more capabilities of the discovered MFP; and
sending instructions to the discovered MFP for fulfilling the request.

24. The method of claim 21, further comprising:
translating the received request according to a native set of instructions of the first MFP to obtain the instructions for sending to the discovered MFP.
